(19) United States
(12) Patent Application Publication
(10) Pub. No.: US 2025/0055285 A1
(43) Pub. Date: Feb. 13, 2025

(54) POLYPHASE AND DC VOLTAGE SUPPLY SYSTEM AND ASSOCIATED SUPPLY METHOD

(71) Applicant: Commissariat à l'énergie atomique et aux énergies alternatives, Paris (FR)

(72) Inventors: Leandro CASSARINO, Grenoble (FR); Ghislain DESPESSE, Grenoble (FR)

(73) Assignee: Commissariat à l'énergie atomique et aux énergies alternatives, Paris (FR)

(21) Appl. No.: 18/723,119

(22) PCT Filed: Dec. 21, 2022
(86) PCT No.: PCT/EP2022/087331

§ 371 Date: Jun. 21, 2024

(30) Foreign Application Priority Data
Dec. 23, 2021 (FR) FR2114417

(51) Int. Cl. H02J 4/00; H02J 7/00

(52) U.S. Cl. CPC H02J 4/00; H02J 7/0024; H02J 2207/20

(57) ABSTRACT

A power supply system adapted to provide a polyphase voltage and a DC voltage and including at least three modules, each module including a set of cells, each cell including at least one elementary power source, the set of cells including a first cell and a second cell, a polarity switching circuit of the module, an output allowing a phase of the power supply system to be generated, the polarity switching circuit being connected to two opposite poles of the two cells, respectively, a selection circuit selecting cells to be connected to the polarity switching circuit, and control circuits connecting two opposite poles of the two cells to a positive and a negative DC voltage output, respectively.

The present invention relates to a polyphase and DC voltage supply system. The invention further relates to a corresponding supply method.

Energy optimization in battery-powered stand-alone systems is very important because on-board energy is limited by cost, weight and volume.

In a stand-alone system, the battery provides the power needed to supply a plurality of elements or peripherals of the system. For example, in electric transport systems such as electric bicycles, electric cars, electric scooters among others, the battery can power at the same time a three-phase electric motor, a lighting device or a human-machine interface.

Thereby, in the case of a system comprising a three-phase electric motor and one or a plurality of devices to be supplied continuously, a battery pack is used to supply both the motor and the other devices.

More precisely, for the supply of the electric motor, the energy of the three phases is taken from the same battery pack by an inverter. The inverter is used to convert the DC voltage leaving the battery pack into the three AC voltages, forming the three phases of the device to be supplied with power.

For other devices to be supplied, the output voltage of the battery is further used to generate the different supply voltages through at least one DC/DC converter.

The above means that in addition to the battery pack(s), an inverter and at least one DC/DC converter are used, which means losses in energy consumptions.

There is thus a need for a power supply system which can supply both a DC voltage and a polyphase voltage with reduced losses of energy consumptions.

To this end, the description describes a power supply system suitable for supplying a polyphase voltage and a direct voltage, the power supply system comprising at least three modules, each module including:
a set of cells, each cell comprising at least one elementary source of energy, the set of cells including a first end cell and a second end cell each having a negative pole and a positive pole,
a polarity switchover circuit of the module, the switchover circuit having an output for generating a phase of the power supply system (10), the negative pole of the first end cell being connected to the polarity switchover circuit and the positive pole of the second end cell being connected to the polarity switchover circuit,
a selection circuit suitable for selecting cells from the set of cells to obtain a set of selected cells to be connected to the polarity switchover circuit for generating the phase of the power supply system of the output,
a first control circuit suitable for connecting the positive pole of the first end cell to a positive DC voltage output of the power supply system, and
a second control circuit suitable for connecting the negative pole of the second end cell to a negative DC voltage output of the power supply system.

It should be understood here that the present invention proposes to use a battery with switched accumulators as a battery pack. A switched storage battery is a battery comprising a plurality of generally identical modules connected in series and/or in parallel, the number of which depends on the desired voltage across the battery. Each module comprises a plurality of electric accumulators. Switches connected in series and in parallel with the accumulators enable each accumulator or set of accumulators either to be or not to be connected in series and/or in parallel between output nodes of the module, so as to choose the output voltage from the different combinations of voltages supplied by the accumulators.

In fact, one advantage of a switching battery is to avoid the use of an inverter.

As a result, it is thereby possible to have reduced losses in energy consumption, compared with the prior art.

However, the present invention solves an additional problem.

Indeed, using a switching battery for a three-phase power supply, used e.g. to supply an electrical machine, presumes separating the battery into three subassemblies, each attached to a phase. Each subassembly has two output poles, one pole is connected to the three-phase machine to form a phase and the other pole is used to produce the neutral point of the power supply. More precisely, the so-called “neutral” poles of each subassembly are connected to each other to form the neutral point.

To supply additional DC devices from the switching battery, at least one switched-mode power supply could be used to draw a DC voltage from one of the subassemblies.

But the energy is to be drawn from the three subsets in a balanced way, so as not to unbalance the subassemblies with regard to each other. Indeed, if one of the subassemblies has discharged, the subassembly no longer supplies current for the three-phase motor. The three-phase motor is then no longer supplied whereas the other two subassemblies still have available energy. Switched-mode power supplies could then be used for all the subassemblies, but the system would be bulky and expensive.

By means of the proposed circuit, the present invention provides a solution to the technical balancing problem by permitting the generation of both a direct voltage and a polyphase voltage for all use cases.

Moreover, it may also be noted herein that the selection circuit is to be understood as a circuit for selecting cells participating in the supply of the polyphase voltage. As such, a selection of no cell (for the case of a passage to 0V for one phase), of one cell or of two cells are possible selection configurations, as well as a selection with more than two cells.

According to particular embodiments, the power supply system has one or a plurality of the following features, taken individually or according to all technically possible combinations:
the polarity switchover circuit is an H-bridge including a switch in each vertical part of the H.
the H-bridge has two output points, a first output point being connected to the neutral point of the power system and a second output point being a phase of the power supply system.
the power supply system includes a control unit configured to simultaneously control at least one control circuit among the first control circuit and the second control circuit and a switch of the H-bridge.
at least one of the first control circuits and the second control circuits is a switch.
each switch is a transistor.
each elementary energy source is a charge storage element or generator.
the selection circuit is suitable for putting in parallel, putting in series and/or bypassing the cells to form the set of selected cells.
the modules are identical.

To this end, the description describes a method of providing a power supply implemented by a power supply system as described hereinabove, wherein the method includes the control of the circuits of the power supply system so that the power supply system provides a desired DC voltage and a desired polyphase voltage, in particular a three-phase voltage.

According to particular embodiments, the supply method has one or a plurality of the following features, taken individually or according to all technically possible combinations:
since the switchover circuit also has an output connected to the neutral point of the power supply system, the method includes a step:
   of connection of the second end cells of at least one module by controlling, for each of the at least one module concerned:
   the second control circuit to connect the negative pole of the second end cell to a negative DC voltage output, and
   the polarity switchover circuit to connect the positive pole of the second end cell to the neutral point power system, and
of connection of the first end cell of at least one other module by controlling, for each of the at least one other module concerned:
   the first control circuit to connect the positive pole of the first end cell to a positive DC voltage output, and
   the polarity switchover circuit to connect the negative pole of the first end cell to the neutral point of the power supply system.
each of the first control circuit and the second control circuit is a switch having an open position and a closed position, the steps of controlling the connection of each of the control circuits are performed by sending a control to the respective switch to switch to the closed position.
the polarity switchover circuit of each module is an H-bridge including a switch in each vertical part of the bridge, each switch having an open position and a closed position, the control of the polarity switchover circuit to connect the positive pole of the second end cell of a module to the neutral point of the power supply system is achieved by controlling on said module:
   the switch connected to the positive pole of the second end cell and to the neutral point to switch to the closed position, and
   the switch connected to the neutral point and the negative pole of the first end cell to switch to the open position.
the polarity switchover circuit of each module is an H-bridge including a switch in each vertical part of the bridge, each switch having an open position and a closed position, the control of the polarity switchover circuit to connect the negative pole of the first end cell of a module to the neutral point of the power supply system is achieved by controlling on said module:
   the switch connected to the positive pole of the second end cell and to the neutral point to switch to the open position, and
   the switch connected to the neutral point and to the negative pole of the first end cell to switch to the closed position.
the polarity switchover circuit of each module is an H-bridge including a switch in each vertical part of the bridge, each switch having an open position and a closed position, the method providing a zero polyphase voltage by controlling polarity switchover circuits so that at all times:
   for one of the modules, the switches of the polarity switchover circuit connected to the positive pole of the second end cell are in a closed position, the other switches of the polarity switchover circuit being in an open position, and
   for another of the modules, the switches of the polarity switchover circuit connected to the negative pole of the first end cell are in a closed position, the other switches of the polarity switchover circuit being in an open position.

The features and advantages of the invention will appear upon reading the following description, given only as an example, but not limited to, and making reference to the enclosed drawings, wherein:

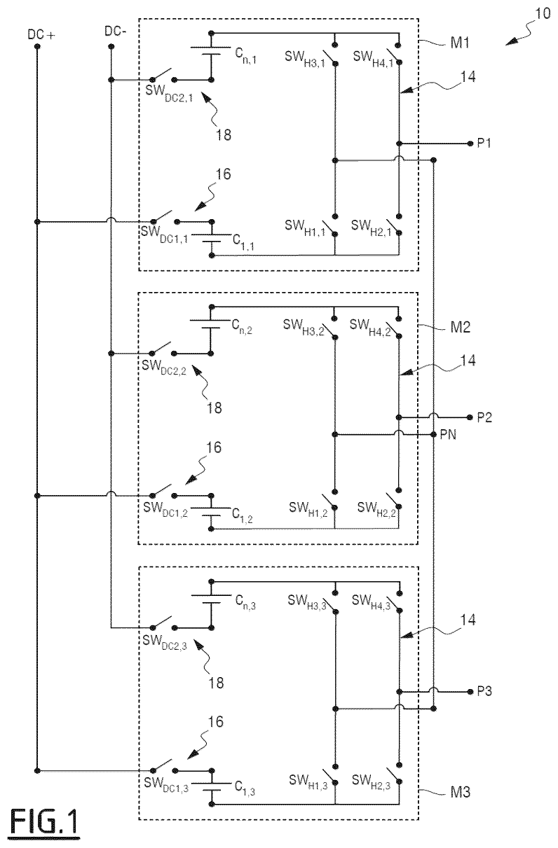

FIG. 1 is a schematic view of an example of a power supply system,

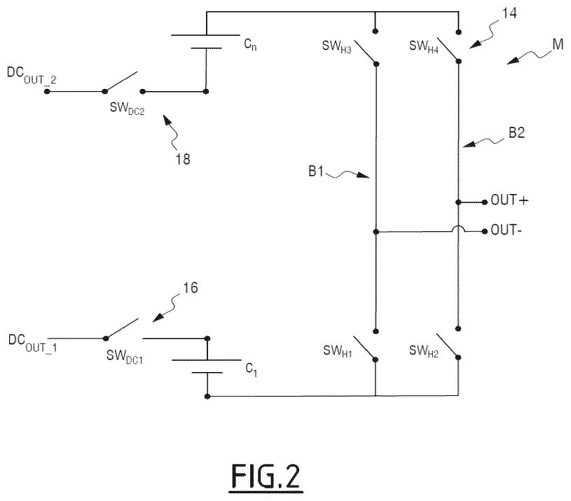

FIG. 2 is a schematic view a part of the power supply system shown in FIG. 1,

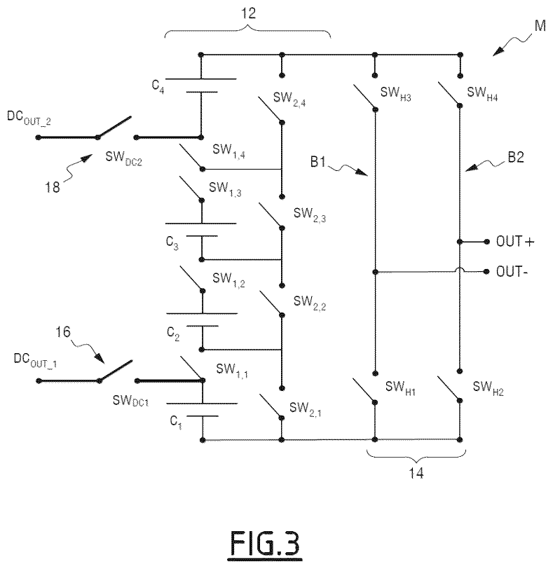

FIG. 3 is a schematic view of an example of a four cell module,

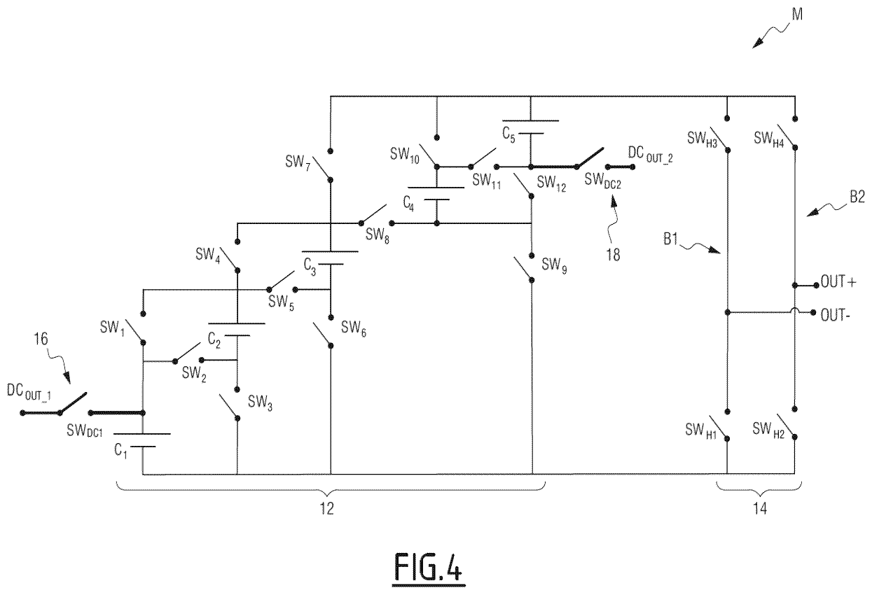

FIG. 4 is a schematic view of an example of a five cell module,

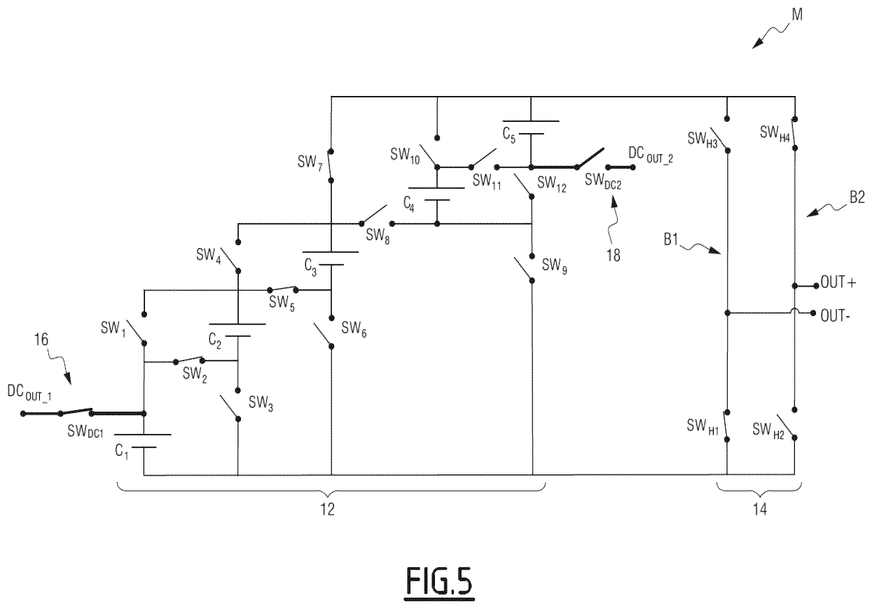

FIG. 5 is a schematic view of the module shown in FIG. 4 in a first configuration,

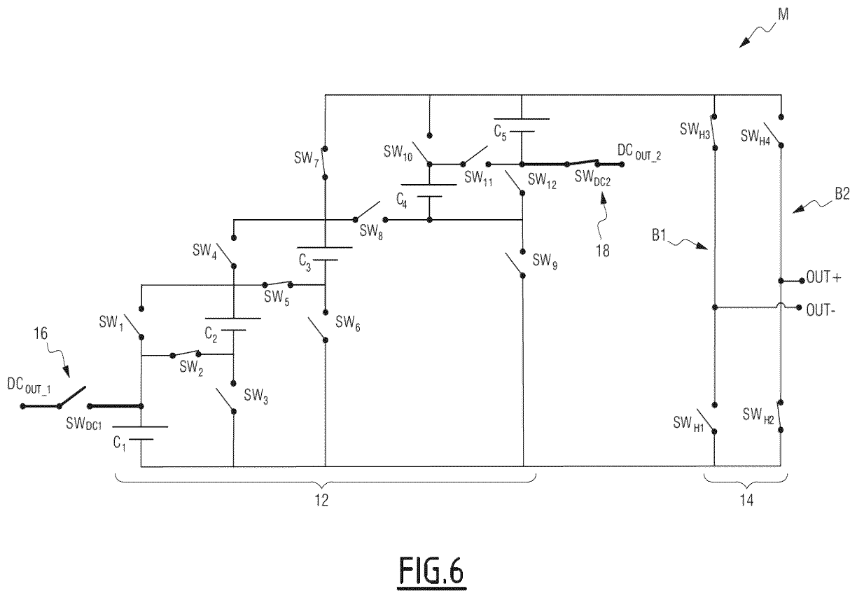

FIG. 6 is a schematic view of the module shown in FIG. 4 in a second configuration,

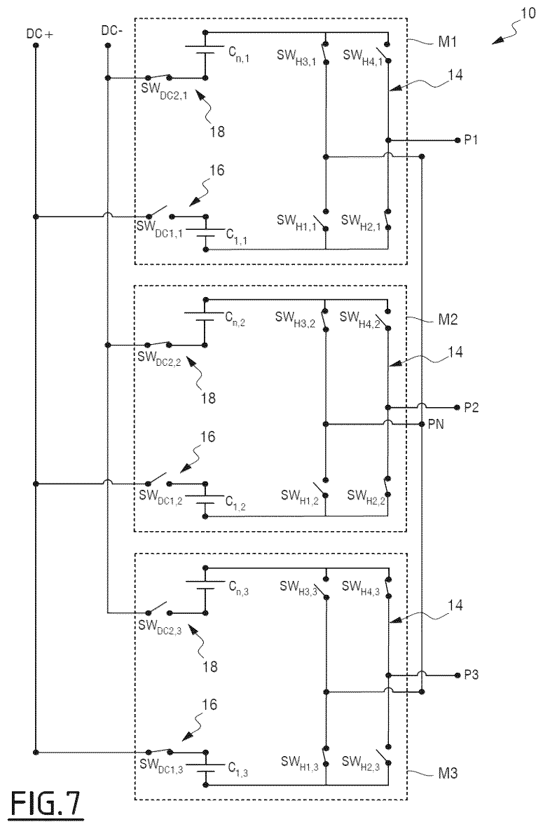

FIG. 7 is a schematic view of the power supply system shown in FIG. 1, in a first configuration,

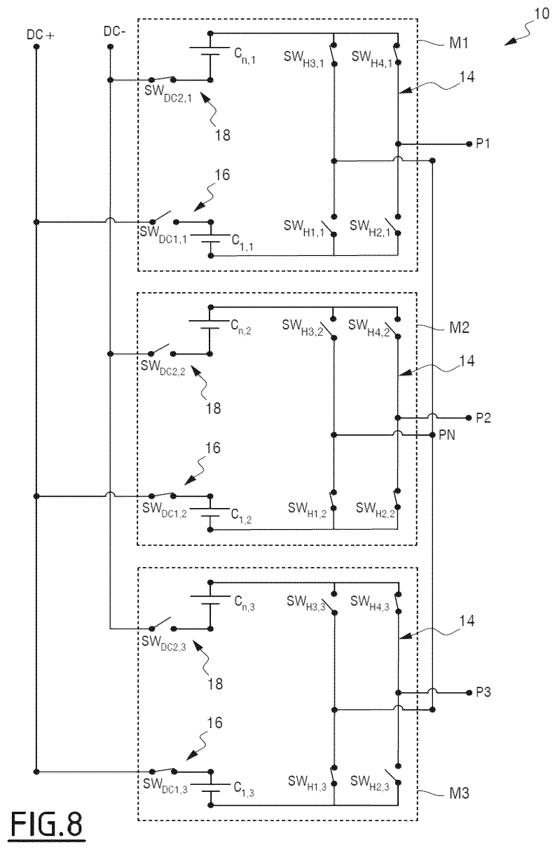

FIG. 8 is a schematic view of the power supply system shown in FIG. 1, in a second configuration, and

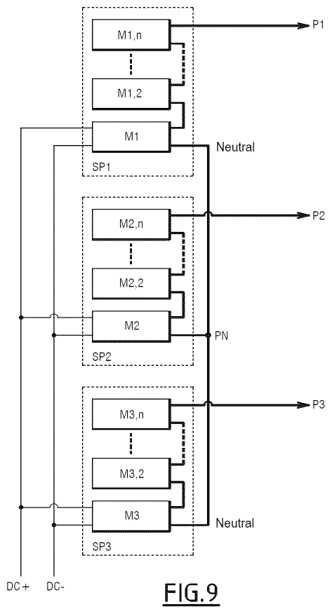

FIG. 9 is a schematic view of the power supply system shown in FIG. 1, in a third configuration.

A power supply system 10 is illustrated in FIG. 1.

The power supply system 10 is a system ensuring the generation of a direct voltage at the output as well as a polyphase voltage operation, whether for the supply of a load with polyphase voltage or the recharging on a polyphase source and of a direct voltage at the output. The power supply system 10 is thus a DC and polyphase voltage supply system.

In the example described, the power supply system 10 is configured to generate three phases, but it is easy to adapt the power supply system 10 so that same can generate a number of phases greater than or equal to 3.

The power supply system 10 includes a “neutral” point PN, an output for each phase P1, P2 and P3, a positive pole corresponding to a positive DC voltage output DC+ and a negative pole corresponding to a negative DC voltage output DC−.

As can be seen in FIG. 1, the power supply system 10 comprises three subsystems M1, M2 and M3.

Each subsystem M1, M2 and M3 corresponds to a module of a switching cell battery which is shown more precisely in FIG. 2.

Each module M includes a plurality of cells C₁ . . . . Cₙ where n is an integer strictly greater than 1.

In the schematic example shown in FIG. 1, only two cells C₁ and Cₙ of each module M1, M2 and M3 are shown, with the proviso that other cells (which would then have as reference sign C₂ to Cₙ₋₁) may also be present.

As an illustration, FIG. 3 proposes a module M with four cells C₁, C₂, C₃ and C₄ and FIG. 4 shows another example of a module M with five cells C₁, C₂, C_{3,C4} and C₅.

A cell C may comprise between the positive and negative poles thereof, one or a plurality of elementary energy sources placed in series and/or parallel. The voltage step of a cell C is often on the order of 3.6 V, 12 V, 24 V or 48 V but any other value is possible.

For example, the elementary energy source is an electrical charge storage element, such as an electrochemical element or an electrical capacitor.

According to another example, the elementary energy source is an electric generator, e.g. a fuel cell, a zinc-air cell, a photovoltaic cell.

In yet another example, the elementary energy source is an energy recovery system, such as a mini-wind turbine or mini-turbine.

The elementary energy sources of cell C may have a mixed nature, e.g. a combination of an electrical generator and a storage element.

Each module M further includes a selection circuit 12 and a polarity switchover circuit 14 for obtaining the desired voltage(s) at the output of the module.

The selection circuit 12 is a set of switches connected to the cells C for connecting in series/parallel or for bypassing certain cells, by changing the state (opening or closing) of the switches.

More precisely, the selection circuit 12 is configured to select cells C to obtain a set of selected cells, which will participate in the generation of the phase.

The set of cells C further comprises a first end cell C₁ the negative pole of which is connected to the polarity switchover circuit 14, and a second end cell Cₙ, the positive pole of which is connected to the polarity switchover circuit 14. The first and second end cells C₁ and Cₙ form part of the set of cells C, and as such may be a part of a set of cells selected, but this is not mandatory.

For the case of FIG. 6, the first end cell is the first cell C₁ and the second end cell is the 5-th cell C₅.

In the case of FIG. 2, the selection circuit 12 is not shown but it is visible for the cases of FIGS. 3 and 4.

More particularly, the module M of FIG. 3 includes eight switches, four first switches SW_{1.1}, SW_{1.2}. SW_{1.3} and SW_{1.4} enabling the cells C₁, C₂, C₃ and C₄ to be connected in series and four second switches SW_{2.1}, SW_{2.2}. SW_{2.3} and SW_{2.4} serving to bypass the cells C₁, C₂, C₃ and C₄. The module M shown in FIG. 4 corresponds to another assembly involving twelve switches SW₁ to SW₁₂.

The switches SW are e.g. transistors having an on state and an off state. Typically, insulated-gate field-effect transistors may be used, more commonly called MOSFETs. MOSFET is an acronym for Metal Oxide Semiconductor Field-Effect Transistor.

The polarity switchover circuit 14 is used to switchover the polarity of the set of selected cells, i.e. the polarity switchover circuit 14 is used to either invert or not invert the polarity of the connected cells.

In the example proposed, the polarity switchover circuit 14 is an H-bridge.

The H-bridge includes four switches SW_{H1}, SW_{H2}, SW H3, and SW_{H4}.

The H-bridge comprises two branches B1 and B2 in parallel, namely a first branch B1 including, in series, the first switch SW_{H1} and the third switch SW_{H3} and a second branch B2 including, in series, the second switch SW_{H2} and the fourth switch SW_{H4}.

Each branch B1 and B2 has a respective midpoint for extracting a voltage, the midpoint of the first branch B1 corresponding to a negative output OUT− and the midpoint of the second branch B2 corresponding to a positive output OUT+. The output voltage of the H-bridge corresponds to the difference of potential difference the positive output OUT+ and the negative output OUT−.

In the example described, branches B1 and B2 are connected between the negative terminal of the first cell C₁ and the positive terminal of the nth cell Cₙ. More precisely, the negative terminal of the first cell C₁ is connected to the first switch SW_{H1} and to the second switch SW_{H2} whereas the positive terminal of the nth cell Cₙ is connected to the third switch SW_{H3} and to the fourth switch SW_{H4}.

According to the representation chosen in FIG. 2 where the first cell C₁ and the nth cell Cₙ are at the top, the first switch SW_{H1} and the second switch SW_{H2} correspond to the bottom of the H-bridge whereas the third switch SW_{H3} and the fourth switch SW_{H4} correspond to the top of the H-bridge.

The H-bridge is used to generate positive and negative sign voltages, according to the configuration of the switches of the H-bridge, as will be described with reference to FIGS. 5 and 6.

In the example shown in FIG. 5, to generate a positive voltage, switches SW_{H1} and SW_{H4} of the H-bridge has to be closed.

FIG. 5 shows an example of such a connection, with the first, second and third cells C₁, C₂ and C₃ connected in series (through the closing of switches SW₂, SW₅, and SW₇) and connected to the output by the H-bridge.

In the case of FIG. 5, the H-bridge is in the “positive” configuration thereof, i.e. a configuration wherein the first and fourth switches SW_{H1} and SW_{H4} are closed. The output voltage of the H-bridge is positive and corresponds in amplitude to the voltage of three cells C₁, C₂ and C₃ in series. The fourth and fifth cells C₄ and C₅ are spaced apart since same are not connected to the output of the H-bridge.

In the case of FIG. 6, the H-bridge is in the “negative” configuration thereof, i.e. a configuration wherein the second and third switches SW_{H2} and SW_{H3} are closed. The output voltage of the H-bridge is negative and corresponds in amplitude to the voltage of three cells C₁, C₂ and C₃ in series.

Each module M further includes two control circuits 16 and 18.

The first control circuit 16 is configured to connect the positive pole of the first cell C₁ to the positive pole DC+ of the power supply system 10 whereas the second control circuit 18 is configured to connect the negative pole of the nth cell Cₙ to the negative pole DC− of the power system 10.

In the example described, each control circuit 16 or 18 corresponds to a switch, a first control switch SW_{DC1} for the first control circuit 16 and a second control switch SW_{DC2} for the second control circuit 18, respectively.

Thereby, the first cell C₁ is connected between the bottom of the H-bridge and the first control switch SW_{DC1}.

The nth cell Cₙ is connected between the top of the H-bridge and the second control switch SW_{DC2}.

The closing of the control switches SW_{DC1} and SW_{DC2} connects the potential DC_{OUT1} and DC_{OUT2} to the positive pole of the first cell C₁ and to the negative pole of the nth cell Cₙ, respectively.

From the point of view of the DC+ and DC− outputs of the power supply system 10, good synchronization should be provided between the switches SW_{H1}, SW_{H2}, SW_{H3} and SW_{H4} of the H-bridge and the control switches SW_{DC1} and SW_{DC2}.

More particularly, when the H-bridge is in the positive configuration (with the switches SW_{H1} and SW_{H4} closed) thereof, it is recommended to close the first control switch SW_{DC1} at the same time and when the H-bridge is in the negative configuration (with the switches SW_{H2} and SW_{H3} closed) thereof, it is recommended to close at the same time the second control switch SW_{D2}, as can be seen in FIGS. 5 and 6.

As an example, to provide good synchronization, it may be envisaged to simultaneously control a control switch SW_{DC1} and SW_{DC2} with one of the switches SW_{H1}, SW_{H2}, SW_{H3} and SW_{H4} of the H-bridge. Thereby, the control switches SW_{DC1} and SW_{H1} can be controlled by the same signal and similarly, the switches SW_{DC2} and SW_{H3} can be controlled by the same signal.

To this end, the modules M are equipped with a control unit which is suitable for sending control laws adapted to the selection circuit 12 and to the polarity switchover circuit 14 and thereby to control all the switches SW.

Each module M includes, in addition to the positive output OUT+ and to the negative output OUT−, two DC outputs, which will be referred to hereinafter as positive pole DC_{OUT_1} and negative pole DC_{OUT_2}.

With reference to FIG. 1, it can be seen that the negative output OUT-corresponds to the “neutral” output and the positive output OUT+ corresponds to a phase.

In fact, the three negative outputs OUT− of the three modules M1, M2 and M3 are connected together to form the neutral point PN of the power supply system 10.

The three phases P1, P2 and P3 form the three-phase output of the power supply system 10.

The three positive poles DC_{OUT_1} of the three modules M1, M2 and M3 are connected together to form the positive pole DC+ of the power supply system 10.

The three negative poles DC_{OUT_2} of the three modules M1, M2 and M3 are also connected together to form the negative pole DC− of the power supply system 10.

A DC voltage is thereby obtained between the two poles DC+ and DC− of the DC output of the power supply system 10 from the three DC outputs DC_{OUT_1} and DC_{OUT_2} of the three modules M1, M2 and M3.

It will now be explained why such an arrangement makes it possible to guarantee that the power supply system 10 can supply both a direct voltage and a polyphase voltage in all cases of use.

It should be noted that, in a three-phase system, the output voltages are centered at 0 V and at each instant, at least 2 of the 3 phases are of opposite sign. When one phase changes sign (from positive to negative voltage, or vice versa), the other two phases have an opposite sign, so there will always be two phases of opposite sign, among the three.

The above remains true even with discretized signals and even if a harmonic (e.g. of order 3, i.e. a signal of the form A.Sin (ωt)+B.Sin (3ωt)) is added.

As a result, the H-bridge always sees two phases of opposite sign, in any configuration (positive and negative). The above makes it possible to generate a DC voltage at the output of the power supply system 10 (in addition to the three-phase voltage).

FIG. 7 shows the power supply system 10 of FIG. 1 in a configuration that provides a three-phase voltage at the output of the H-bridge and, at the same time, a DC voltage at the DC output thereof.

In the present example, the two modules M1 and M2 positioned at the top (first and second modules in the following sequence) generate a negative voltage at the output of the H-bridge (between P1 and PN and between P2 and PN) thereof and the module M3 positioned at the bottom (third module hereinafter) generates a positive voltage at the output of the H-bridge (between P3 and PN).

The negative poles of the two nth cells C_{n,1} and C_{n,2} of the first and second modules M1 and M2 are connected to the negative pole DC− of the power supply system 10, the control switches SW_{DC2,1} and SW_{DC2,2} being in the closed state.

The positive poles of the two n-th cells C_{n,1} and C_{n,2} of the first and second modules M1 and M2 are connected to the neutral point PN, the switches SW_{H3,1} and SW_{H3,2} being in the closed state.

Thereby, the two nth cells C_{n,1} and C_{n,2} of the first and second modules M1 and M2 are connected in parallel with each other.

The positive pole of the first cell C13 of the third module M3 is connected to the positive pole DC+ of the power supply system 10, the control switch SW_{DC1,3} being in the closed state.

The negative pole of the first cell C_{1,3} of the third module M3 is connected to the neutral point PN, the switch SW_{H1,3} being in the closed state.

Thereby, the first cell C13 of the third module M3 is connected in series to the two nth cells C_{n,1} and Cₙ₂ of the first and second modules M1 and M2 and to the two poles DC− and DC+ of the power supply system 10, a voltage equivalent to two cells connected in series (C₁+Cₙ) is present.

Such a configuration serves to continually obtain a continuous voltage.

Indeed, even if the configuration of the three-phase signal changes, with e.g. a first module with a positive output voltage and the other two modules with a negative output voltage, there are always two modules with opposite output voltage and hence the first cell C₁ of a module in series with the nth cell Cₙ of another module. The sum of the voltage thereof is thereby continually available on the two poles DC− and DC+ of the power supply system 10.

Furthermore, when the first cells C₁ of the three modules M1, M2 and M3 have the same voltage and the n-th cells Cₙ of the three modules M1, M2 and M3 have the same voltage, the DC voltage at the output of the power supply system 10 has very small variations when the configuration of the three-phase signal is changed. It is thereby favorable that each of the three modules M1, M2 and M3 are identical, which is the case for FIG. 1.

The power supply system 10 is also configured to deliver a DC voltage when the three-phase output of the power system is zero. The above point now be explained with reference to FIG. 8.

It should first be noted that a discretized voltage, leaving an inverter, is often modulated in order to improve the performance and the quality of the current exchanged (e.g. with an electric motor).

When modulation is made between zero and the first (or the only) stage of the inverter (with modulation between zero and one cell, in the present case), the voltage can be at zero a plurality of times during the electrical period.

For the case shown in FIG. 8, the above means that the H-bridges can generate a zero voltage with two different configurations: by closing the bottom switches SW_{H1} and SW_{H2} or by closing the top switches SW_{H3} and SW_{H4}. With both configurations, the H-bridge outputs are short-circuited.

In order to ensure the generation of the DC voltage even in such case, a specific H-bridge configuration is used, depending on whether the system is in the first or in the second half of the electrical period of the modulated voltage.

In order to ensure the generation of the DC voltage, the zeros of the first half of the voltage period will be generated by closing the bottom switches SW_{H1}, SW_{H2} of the H-bridge and at the same time the first control switch SW_{DC1} (which was already closed during the generation of the positive plateau preceding the zero). Such configuration, called “zero plus”, allows the first cell C₁ to be connected between the positive pole DC+ and the neutral point PN of the power supply system 10, as for the generation of a positive voltage.

Similarly, the zeros of the second half of the voltage period will be generated by closing the top switches SW_{H3}, SW_{H4} of the H-bridge and at the same time the second control switch SW_{DC2} (which was already closed during the generation of the negative plateau preceding the zero). Such configuration, called “zero minus”, makes it possible to connect the n-th cell Cₙ between the negative pole DC− and the neutral point PN of the power supply system 10, as for the generation of a positive voltage.

In this way, at least a first cell C₁ of a module M is always connected between the positive pole DC+ and the neutral point PN of the power supply system 10 (with the generation of a positive voltage or a “zero plus” at the output of the H-bridge of the corresponding module M), and an n-th cell Cₙ, connected between the negative pole of the DC+ output and the neutral point PN of the power supply system 10 (with the generation of a negative voltage or “zero minus” at the output of the H-bridge of the corresponding module). The two cells are in series and the sum of the voltage (C₁+Cₙ) thereof is present on the DC output of the power supply system 10.

FIG. 8 shows the case of a power supply where the first phase corresponds to a “zero minus” configuration, the second phase corresponds to a “zero plus” configuration and the third phase corresponds to a positive voltage at the output of the H-bridge thereof. At the DC output, we find the voltage of the first cells C_{1,2} and C_{1,3} in parallel, in series with the n-th cell C_{n,1}.

It is thereby possible to generate the DC voltage for the power supply system 10, even when the three-phase output of the power supply system 10 is zero (e.g. if the electric motor is stopped). Indeed, if each M module generates a periodic series of configurations (which can be stored in memory), where the first half of the period is composed of “zero plus” configurations and the second half of the period is composed of “zero minus” configurations, and the series generated by the 3 modules M1, M2 and M3 are phase shifted by one third of the period or by π/3 (as for the generation of a three-phase voltage), there will always be at least one module M that generates a “zero plus” and at least one module M that generates a “zero minus”.

It has thereby been shown that the power supply system 10 described can supply both a direct voltage and a polyphase voltage in all use cases.

More generally, FIG. 9 also shows that the modules M1, M2, M3 can be a part of a plurality of distinct sub-packs (SP1, SP2 and SP3, respectively), each sub-pack SP supplying both the voltage DC and a phase of the polyphase system. Each sub-pack SP gathers a set of modules: the first sub-pack SP1 gathers the first module M1 and first additional modules denoted by M1,2, M1,3 . . . . M1,n in FIG. 9, the second sub-pack SP2 gathers the second module M2 and second additional modules denoted by M2,2, M2,3 . . . . M2,n in FIG. 9 and the third sub-pack SP3 gathers the third module M3 and second additional modules denoted by M3,2, M3,3 . . . . M3,n in FIG. 9.

Thereby, the generation of a phase by modules M1, M2, M3 should be understood either as the supply of a phase or as a contribution to the supply of a phase. In other words, the modules M1, M2 and M3 allow the generation of a phase in the sense that each of the modules serves to generate a phase alone or in combination with other modules, e.g. in the context of a sub-pack SP as shown in FIG. 9. Another way of formulating the notion relating to the expression “serves to generate a phase” is that each module M1, M2 or M3 directly generates or contributes to generating a phase.

Furthermore, the power supply system 10 is easy to implement (smaller bulk and relatively low cost) compared to a system involving switched-mode power supplies.

The supply system 10 may correspond to any combination of the preceding embodiments, more particularly, each module may be the module shown in FIG. 2, 3 or 4.

1. A power supply system configured to supply a polyphase voltage and a direct voltage, the power supply system comprising at least three modules, each module, including:
a set of cells, each cell including at least one elementary source of energy, the set of cells including a first end cell and a second end cell, each having a negative pole and a positive pole,
a polarity switchover circuit of the module, the switchover circuit having an output for generating a phase of the power supply system, the negative pole of the first end cell being connected to the polarity switchover circuit and the positive pole of the second end cell being connected to the polarity switchover circuit,
a selection circuit configured to select cells from the set of cells to obtain a set of cells selected to be connected to the polarity switchover circuit for generating the phase of the power supply system of the output,
a first control circuit configured to connect the positive pole of the first end cell to a positive DC voltage output of the power supply system, and
a second control circuit configured to connect the negative pole of the second end cell to a negative DC voltage output of the power supply system.

2. The power supply system according to claim 1,
wherein the polarity switchover circuit is an H-bridge having a switch in each vertical portion of the H.

3. The power supply system according to claim 2, wherein the H-bridge has two output points, a first output point being connected to the neutral point of the power supply system and a second output point being a phase of the power supply system.

4. The power supply system according to claim 1, wherein the power supply system includes a control unit configured to simultaneously control at least one control circuit among the first control circuit and the second control circuit and a switch of the H-bridge.

5. The power supply system according to claim 1, wherein at least one control circuit of the first control circuit and the second control circuit is a switch.

6. The power supply system according to claim 1, wherein each switch is a transistor.

7. The power supply system according to claim 1, wherein each elementary source of energy is a charge storage element or a generator.

8. The power supply system according to claim 1, wherein the selection circuit is configured to put in parallel, to put in series and/or to bypass the cells to form the set of selected cells.

9. The power supply system according to claim 1, wherein the modules are identical.

10. A supply method for supplying a power supply used by a power supply system according to claim 1, wherein the method includes the control of the circuits of the power supply system so that the power supply system provides a desired DC voltage and a desired polyphase voltage, in particular a three phase voltage.

11. The supply method according to claim 10, wherein the switchover circuit also has an output connected to the neutral point of the power supply system, the method including a step of:
connection of the second end cells of at least one module by controlling, for each of the at least one module concerned:
the second control circuit to connect the negative pole of the second end cell to a negative DC voltage output, and
the polarity switchover circuit to connect the positive pole of the second end cell to the neutral point (PN) of the power supply system, and
connection of the first end cell of at least one other module by controlling, for each of the at least one other module concerned:
the first control circuit to connect the positive pole of the first end cell to a positive DC voltage output, and
the polarity switchover circuit to connect the negative pole of the first end cell to the neutral point of the power supply system.

12. The supply method according to claim 11, wherein each of the first control circuit and the second control circuit is a switch having an open position and a closed position, the steps of controlling the connection of each of the control circuits being performed by controlling the respective switch to switch to the closed position.

13. The supply method according to claim 11, wherein the polarity switchover circuit of each module is an H-bridge having a switch in each vertical part of the bridge, each switch having an open position and a closed position, the control of the polarity switchover circuit to connect the positive pole of the second end cell of a module to the neutral point of the supply system being achieved by controlling on said module:
the switch connected to the positive pole of the second end cell and to the neutral point to switch to the closed position, and
the switch connected to the neutral point and to the negative pole of the first end cell to switch to the open position.

14. The supply method according to claim 11, wherein the polarity switchover circuit of each module is an H-bridge having a switch in each vertical portion of the bridge, each switch having an open position and a closed position, the control of the polarity switchover circuit to connect the negative pole of the first end cell of a module to the neutral point of the supply system being achieved by controlling on said module:
the switch connected to the positive pole of the second end cell and to the neutral point to switch to the open position, and
the switch connected to the neutral point and to the negative pole of the first end cell to switch to the closed position.

15. The supply method according to claim 11, wherein the polarity switchover circuit of each module is an H-bridge including in each vertical portion of the bridge a switch, each switch having an open position and a closed position, the method providing a zero polyphase voltage by controlling the polarity switchover circuits so that at all times:
for one of the modules, the switches of the polarity switchover circuit connected to the positive pole of the second end cell are in a closed position, the other switches of the polarity switchover circuit being in an open position, and
for another of the modules, the switches of the polarity switchover circuit connected to the negative pole of the first end cell are in a closed position, the other switches of the polarity switchover circuit being in an open position.
